(19) United States
(12) Patent Application Publication
(10) Pub. No.: US 2021/0195658 A1
(43) Pub. Date: Jun. 24, 2021

(54) ENABLING COEXISTENCE BETWEEN INTELLIGENT TRANSPORTATION SYSTEM NETWORKS AND UNLICENSED WIRELESS LOCAL AREA NETWORKS

(71) Applicant: QUALCOMM Incorporated, San Diego, CA (US)

(72) Inventor: James LANSFORD, Cascade, CO (US)

(21) Appl. No.: 17/101,841

(22) Filed: Nov. 23, 2020

Related U.S. Application Data
(60) Provisional application No. 62/951,611, filed on Dec. 20, 2019.

(51) Int. Cl. H04W 74/08; H04L 29/06; H04W 72/04; H04W 4/40; H04W 4/80; H04L 5/00

(52) U.S. Cl. CPC H04W 74/0858; H04L 69/08; H04W 72/0453; H04L 5/0055; H04W 4/40; H04W 4/80; H04W 72/0446

(57) ABSTRACT

Certain aspects of the present disclosure provide techniques for enabling coexistence between intelligent transportation system (ITS) networks and unlicensed wireless local area networks (WLANs). A method that may be performed by an intelligent transportation system (ITS) device, includes transmitting one of a frame or a clear-to-send-to-self (CTS-to-self) message indicating a first time period during which a bandwidth will be in use, wherein the frame or CTS-to-self transmission is based on a first protocol; and transmitting, by the ITS device during the first time period and on the bandwidth, signaling, wherein the signaling is based on a second protocol.

### CROSS REFERENCE TO RELATED APPLICATION

This Application hereby claims priority under 35 U.S.C. § 119 to pending U.S. Provisional Patent Application No. 62/951,611, filed on Dec. 20, 2019, the contents of which are incorporated herein in their entirety.

### FIELD OF THE DISCLOSURE

Aspects of the present disclosure relate to wireless communications, and more particularly, to techniques for enabling coexistence between intelligent transportation system (ITS) networks and unlicensed wireless local area networks (WLANs).

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved data throughput and reliability if intelligent transportation system (ITS) network communications.

Certain aspects provide a method for wireless communication by an intelligent transportation system (ITS) device. The method generally includes transmitting one of a frame or a clear-to-send-to-self (CTS-to-self) message indicating a first time period during which a bandwidth will be in use, wherein the transmission of the frame or CTS-to-self message is based on a first protocol and transmitting signaling during the first time period and on the bandwidth, wherein the transmission of the signaling is based on a second protocol.

Certain aspects provide an intelligent transportation system (ITS) device. The ITS device generally includes means for transmitting one of a frame or a clear-to-send-to-self (CTS-to-self) message indicating a first time period during which a bandwidth will be in use, wherein the transmission of the frame or CTS-to-self message is based on a first protocol and means for transmitting signaling during the first time period and on the bandwidth, wherein the transmission of the signaling is based on a second protocol.

Certain aspects provide an intelligent transportation system (ITS) device. The ITS device generally includes a transmitter configured to transmit (1) one of a frame or a clear-to-send-to-self (CTS-to-self) message indicating a first time period during which a bandwidth will be in use, wherein the transmission of the frame or CTS-to-self message is based on a first protocol, and (2) transmit signaling during the first time period and on the bandwidth, wherein the transmission of the signaling is based on a second protocol.

Certain aspects provide an apparatus for wireless communication. The apparatus generally includes a processing system configured to generate (1) one of a frame or a clear-to-send-to-self (CTS-to-self) message indicating a first time period during which a bandwidth will be in use and (2) signaling, and an interface configured to output (i) one of the frame or the clear-to-send-to-self (CTS-to-self) message for transmission, via a first protocol, during the first time period and on the bandwidth and (ii) the signaling for transmission, via a second protocol, during the first time period and on the bandwidth.

Certain aspects provide a computer-readable medium for wireless communication. The computer-readable medium includes codes executable to (1) output, for transmission based on a first protocol, one of a frame or a clear-to-send-to-self (CTS-to-self) message indicating a first time period during which a bandwidth will be in use, and (2) output signaling, for transmission based on a second protocol, during the first time period and on the bandwidth.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIGS. 3A and 3B illustrate vehicle to everything (V2X) communication systems, in accordance with certain aspects of the present disclosure.

FIG. 4 is a flow diagram illustrating example operations for wireless communication, in accordance with certain aspects of the present disclosure.

FIG. 5 shows an exemplary transmission timeline of a device operating according to aspects of the present disclosure.

FIG. 6 illustrates a communications device that may include various components configured to perform the operations illustrated in FIG. 4, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for enabling coexistence between intelligent transportation system (ITS) networks and unlicensed wireless local area networks (WLANs). The Federal Communications Commission (FCC) has previously allocated frequencies from 5850 megahertz (MHz) to 5925 MHz for the ITS band. There have recently been proposals to allocate a portion of that ITS band for unlicensed use. This new allocation could be used by unlicensed devices such as Wi-Fi devices. The band could also be used by other devices in addition to Wi-Fi devices, since the FCC rules do not preclude such use. For ITS devices that might be configured to use the ITS band even though a portion is allocated to unlicensed use, there are mechanisms within the Wi-Fi protocols that would allow these ITS devices to take precedence over ordinary Wi-Fi devices. According to aspects of the present disclosure, systems and methods are provided to allow devices designed for Intelligent Transportation Systems to preempt Wi-Fi transmissions (using portions of existing IEEE 802.11 protocols) to allow safety critical transmissions to occur. ITS devices typically send out messages between vehicles or between vehicles and infrastructure; these types of messages are commonly referred to as vehicle-to-everything (V2X) messages. Examples of ITS communication include but are not limited to Cellular-V2X (C-V2X) and dedicated short-range communications (DSRC).

As used herein, “ITS device” refers to any user equipment (UE) or base station (BS) capable of and configured to communicate according to any ITS protocol, including but not limited to cellular vehicle-to-anything (C-V2X), advanced C-V2X such as 5G NR, and dedicated short-range communications (DSRC) protocols. A C-V2X transceiver in an automobile is an example of an ITS device, as used herein.

The following description provides examples of enabling coexistence between ITS networks and WLANs, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

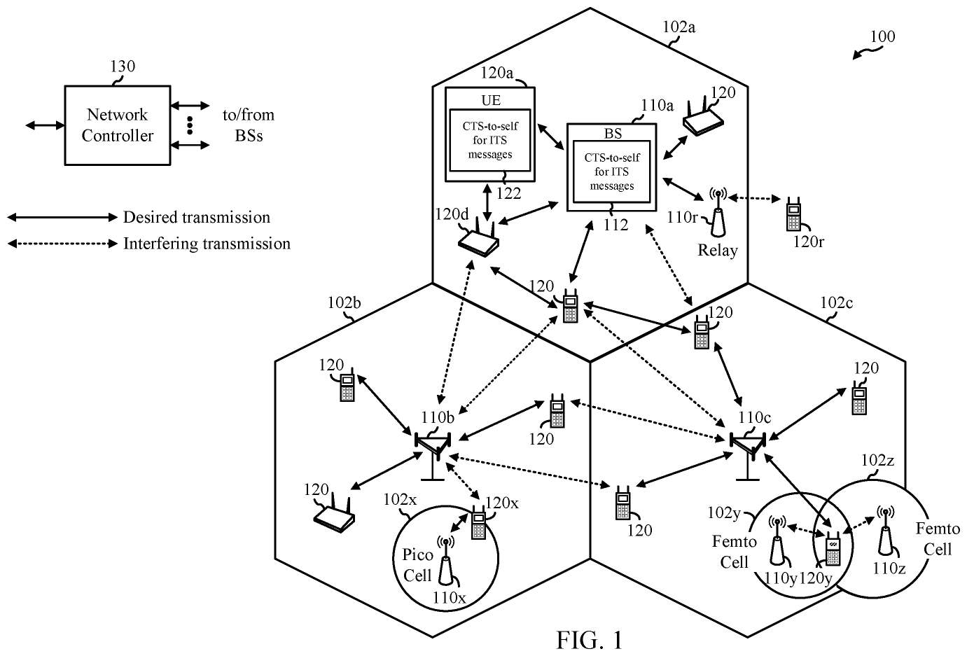

FIG. 1 illustrates an example wireless communication network 100 in which aspects of the present disclosure may be performed. For example, the wireless communication network 100 may be an NR system (e.g., a 5G NR network).

As illustrated in FIG. 1, the wireless communication network 100 may include a number of base stations (BSs) 110a-z (each also individually referred to herein as BS 110 or collectively as BSs 110) and other network entities. In an intelligent transportation system (ITS) network, a BS may also be referred to as a roadside unit (RSU), and a UE may be referred to as an on-board unit (OBU). A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the BSs 110 and UEs 120 may be configured for transmitting CTS-to-self messages prior to transmitting ITS messages. The UEs may also be configured to transmit the CTS-to-self messages prior to transmitting ITS messages to each other. As shown in FIG. 1, the BS 110a includes a CTS-to-self for ITS messages manager 112. The CTS-to-self for ITS messages manager 112 may be configured to transmit, by an intelligent transportation system (ITS) device, at least one of a Wi-Fi transmission opportunity (TXOP) or a Wi-Fi clear-to-send-to-self (CTS-to-self) indicating a period that a bandwidth will be in use; and to transmit, by the ITS device during the period and on the bandwidth, signaling according to an ITS standard, in accordance with aspects of the present disclosure. As shown in FIG. 1, the UE 120a includes a CTS-to-self for ITS messages manager 122. The CTS-to-self for ITS messages manager 122 may be configured to transmit, by an intelligent transportation system (ITS) device, at least one of a Wi-Fi transmission opportunity (TXOP) or a Wi-Fi clear-to-send-to-self (CTS-to-self) indicating a period that a bandwidth will be in use; and to transmit, by the ITS device during the period and on the bandwidth, signaling according to an ITS standard, in accordance with aspects of the present disclosure.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

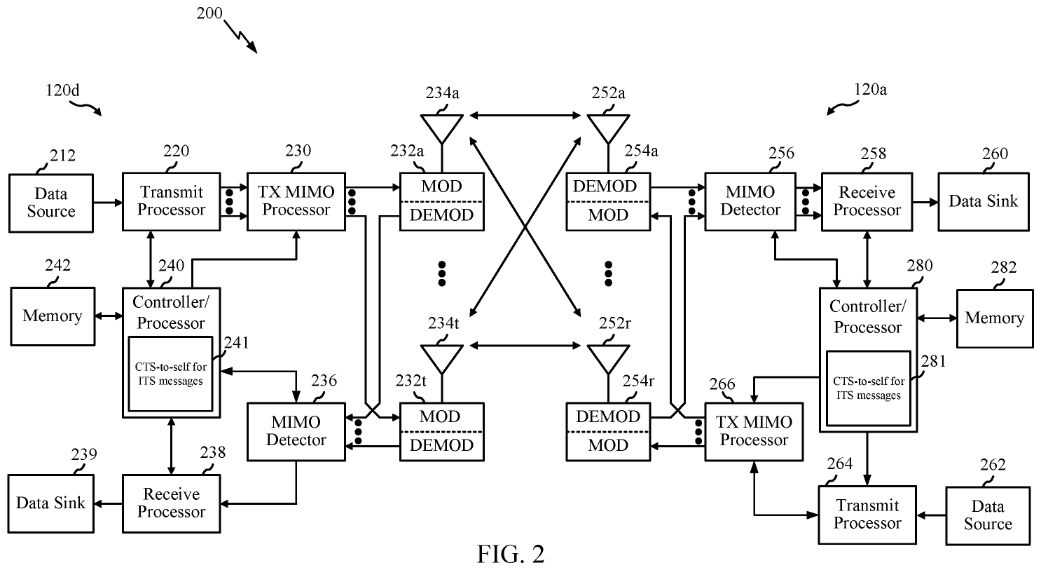

FIG. 2 illustrates example components of UE 120d and UE 120a (e.g., in the wireless communication network 100 of FIG. 1), which may be used to implement aspects of the present disclosure.

At the UE 120d, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the UE 120d and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the UE 120d. At the UE 120d, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for UE 120d and UE 120a, respectively.

The controller/processor 280 and/or other processors and modules at the UE 120a may perform or direct the execution of processes for the techniques described herein. For example, as shown in FIG. 2, the controller/processor 240 of the UE 120d has a CTS-to-self for ITS messages manager 241 that may be configured for transmitting, by an intelligent transportation system (ITS) device, at least one of a Wi-Fi transmission opportunity (TXOP) or a Wi-Fi clear-to-send-to-self (CTS-to-self) message indicating a period that a bandwidth will be in use; and for transmitting, by the ITS device during the period and on the bandwidth, signaling according to an ITS standard, according to aspects described herein. As shown in FIG. 2, the controller/processor 280 of the UE 120a has a CTS-to-self for ITS messages manager 281 that may be configured for transmitting, by an intelligent transportation system (ITS) device, at least one of a Wi-Fi transmission opportunity (TXOP) or a Wi-Fi clear-to-send-to-self (CTS-to-self) message indicating a period that a bandwidth will be in use; and transmitting, by the ITS device during the period and on the bandwidth, signaling according to an ITS standard, according to aspects described herein. Although shown at the Controller/Processor, other components of the UE 120a and UE 120d may be used to perform the operations described herein.

LTE vehicle-to-everything (LTE-V2X) has been developed as a technology to address vehicular wireless communications to enhance road safety and the driving experience.

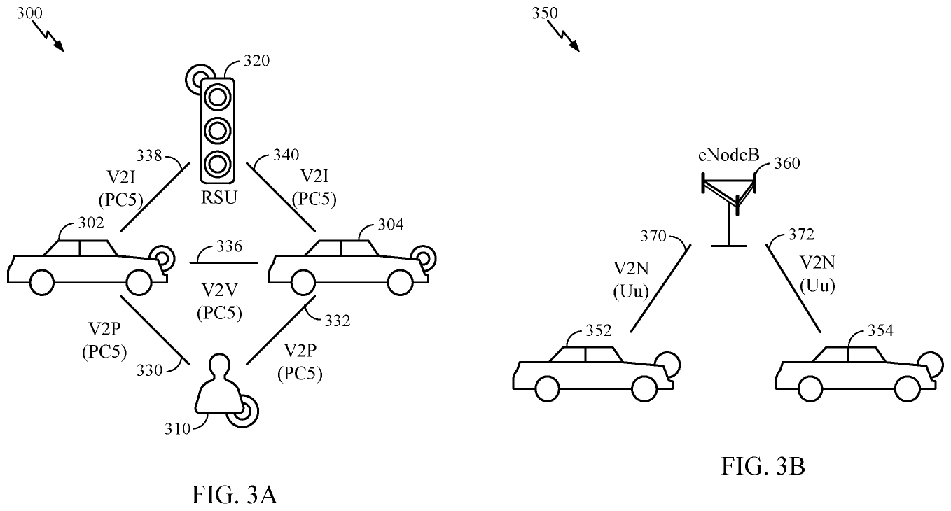

FIGS. 3A and 3B illustrate two complementary transmission modes of exemplary V2X systems 300 and 350. A first transmission mode involves direct communications between participants in the local area. Such communications are illustrated in FIG. 3A. A second transmission mode involves network communications through a network as illustrated in FIG. 3B.

Referring to FIG. 3A, the first transmission mode allows for direct communication between different participants in a given geographic location. As illustrated, a vehicle 302 or 304 can have a communication with an individual 310 (i.e., vehicle-to-pedestrian (V2P)) through a PC5 interface 330 or 332 using transmission mode 3 (TM3) or transmission mode 4 (TM4). Communications between a vehicle and another vehicle (i.e., vehicle-to-vehicle (V2V)) may also occur through a PC5 interface 336. In a like manner, communication may occur from a vehicle to other highway components 320 (e.g., a roadside unit (RSU)), such as a vehicle-to-infrastructure (V2I) signal using a PC5 interface 338 or 340. In each embodiment illustrated, two-way communication can take place between elements, and each element may be both a transmitter and a receiver of information. In the exemplary configuration provided, the first transmission mode is a self-managed system and no network assistance is provided. Such transmission modes provide for reduced cost and increased reliability as network service interruptions do not occur during handover operations for moving vehicles. Resource assignments do not need coordination between operators and subscription to a network is not necessary, therefore there is reduced complexity for such self-managed systems.

The V2X system is configured to work in a 5.9 GHz frequency band, thus any vehicle with an equipped system may access this common frequency band and share information. Such harmonized/common spectrum operations allow for safe operation. In previously known techniques, V2X operations may also co-exist with 802.11p operations by being placed on different channels, and thus those 802.11p operations are not disturbed by the introduction of V2X systems. In one non-limiting embodiment, the V2X system may be operated in a 10 MHz band that may be described as containing basic safety services. In other non-limiting embodiments, the V2X system may be operated over a wider frequency band of 70 MHz to support advanced safety services in addition to basic safety services described above.

Referring to FIG. 3B, a second of two complementary transmission modes is illustrated. In the illustrated embodiment, a vehicle 352 may communicate to another vehicle 354 through network communications. These network communications may occur through discrete nodes, such as eNodeB 360 (or gNodeB), that send and receive information between vehicles (i.e., vehicle-to-network (V2N) signals) via Uu interfaces 370 and 372. The eNodeB 360 may be an example of the base stations 110 illustrated in FIGS. 1 & 2. The network communications may be used, for example, for long range communications between vehicles, such as noting the presence of an accident approximately 1 mile ahead. Other types of communication may be sent by the node to vehicles, such as traffic flow conditions, road hazard warnings, environmental/weather reports, service station availability and other like data. Data can be obtained from cloud-based sharing services.

For network communications, RSUs may be utilized as well as 4G/5G small cell communication technologies in more highly covered areas to allow real time information to be shared among V2X users. As the number of RSUs diminishes, the V2X systems may rely more on small cell communications, as necessary.

In either of the two complementary transmission modes, higher layers may be leveraged to tune congestion control parameters. In high density vehicle deployment areas, using higher layers for such functions provides an enhanced performance on lower layers due to congestion control for PHY/MAC.

The vehicle systems that use V2X technologies may have significant advantages over 802.11 p technologies. Conventional 802.11p technologies have limited scaling capabilities and access control can be problematic. In V2X technologies, two vehicles apart from one another may use the same resource without incident as there are no denied access requests. V2X technologies may also have advantages over 802.11p technologies as these V2X technologies are designed to meet latency requirements, even for moving vehicles, thus allowing for scheduling and access to resources in a timely manner.

In the instance of a blind curve scenario, road conditions may play an integral part in decision making opportunities for vehicles. V2X communications can provide for significant safety of operators where stopping distance estimations may be performed on a vehicle by vehicle basis. These stopping distance estimations allow for traffic to flow around courses, such as a blind curve, with greater vehicle safety, while maximizing the travel speed and efficiency.

PC5 interface based vehicle-to-everything (V2X) communications are normally local to vehicles in proximity to each other. As mentioned above, Wi-Fi and other devices may begin utilizing a portion of the ITS band, possibly impacting throughput and/or latency of ITS communications. Thus, the Wi-Fi and other devices may at times be in close proximity to a vehicle and interfere with V2X communication. Some of these V2X communications are safety-critical.

Accordingly, what is needed are techniques and apparatus for enabling intelligent transportation system (ITS) network devices to take precedence over unlicensed wireless local area network devices, such as Wi-Fi devices.

### Example Enabling Coexistence between Intelligent Transportation System Networks and Unlicensed Wireless Local Area Networks

Aspects of the present disclosure provide techniques for an ITS device to transmit a frame or a clear-to-send-to-self (CTS-to-self) message indicating a first time period during which a bandwidth will be in use, wherein the frame or CTS-to-self transmission is based on a first protocol (e.g., a Wi-Fi protocol); and for the device to then transmit, during the first time period and on the bandwidth, signaling, wherein the signaling is based on a second protocol.

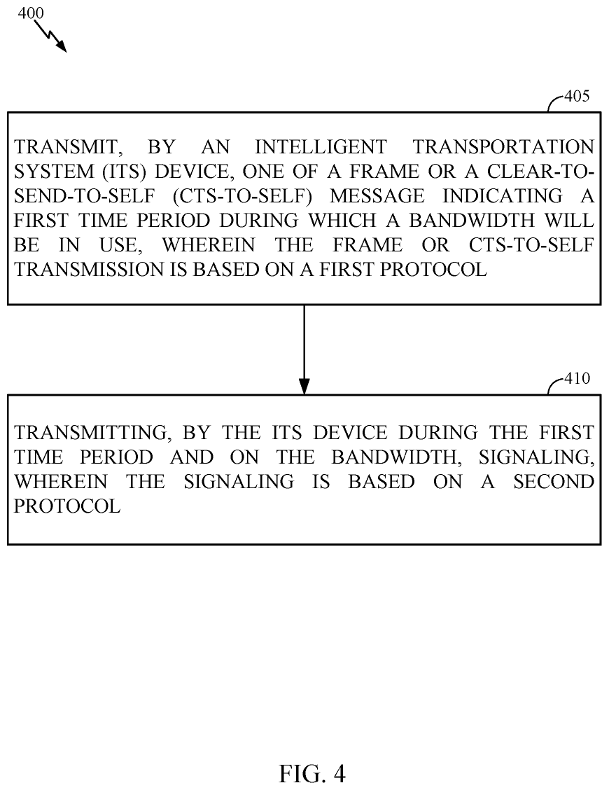

FIG. 4 is a flow diagram illustrating example operations 400 for wireless communication, in accordance with certain aspects of the present disclosure. The operations 400 may be performed, for example, by an intelligent transportation system device (e.g., a UE of a vehicle or a BS in an ITS network, such as the UE 120a in the wireless communication network 100). Operations 400 may be implemented as software components that are executed and run on one or more processors (e.g., controller/processor 280 of FIG. 2). Further, the transmission and reception of signals by the ITS device in operations 400 may be enabled, for example, by one or more antennas (e.g., antennas 252 of FIG. 2). In certain aspects, the transmission and/or reception of signals by the ITS device may be implemented via a bus interface of one or more processors (e.g., controller/processor 280) obtaining and/or outputting signals.

The operations 400 may begin, at block 405, by transmitting, by an intelligent transportation system (ITS) device, one of a frame or a clear-to-send-to-self (CTS-to-self) message indicating a first time period during which a bandwidth will be in use, wherein the frame or CTS-to-self transmission is based on a first protocol.

At block 410, operations 400 may continue with transmitting, by the ITS device during the first time period and on the bandwidth, signaling, wherein the signaling is based on a second protocol.

According to aspects of the present disclosure, the first protocol of block 405 may include a Wi-Fi protocol, and the second protocol of block 410 may be associated with an ITS standard (e.g., C-V2X or DSRC). In some aspects of the present disclosure, the ITS standard may include at least one of a dedicated short-range communications (DSRC) standard, a cellular vehicle-to-everything (C-V2X) standard, or an advanced C-V2X standard such as 5G NR.

In aspects of the present disclosure, the first time period of blocks 405 and 410 may be a transmission opportunity (TXOP).

According to aspects of the present disclosure, the signaling of block 410 may include vehicle mobility data.

In aspects of the present disclosure, a device performing operations 400 may receive an acknowledgment (ACK) of the signaling during the period. In some aspects, the device may determine a length of the period based on: a quantity of data to be transmitted in the signaling; and a length of time for reception of the ACK.

According to aspects of the present disclosure, a device performing operations 400 may detect a communication in the bandwidth prior to the frame or CTS-to-self transmission, wherein the one of the frame or the CTS-to-self message is transmitted after an expiration of a second time period following the end of the communication. In some aspects, the second time period may be a distributed coordination function (DCF) interframe space (DIFS) associated with the first protocol.

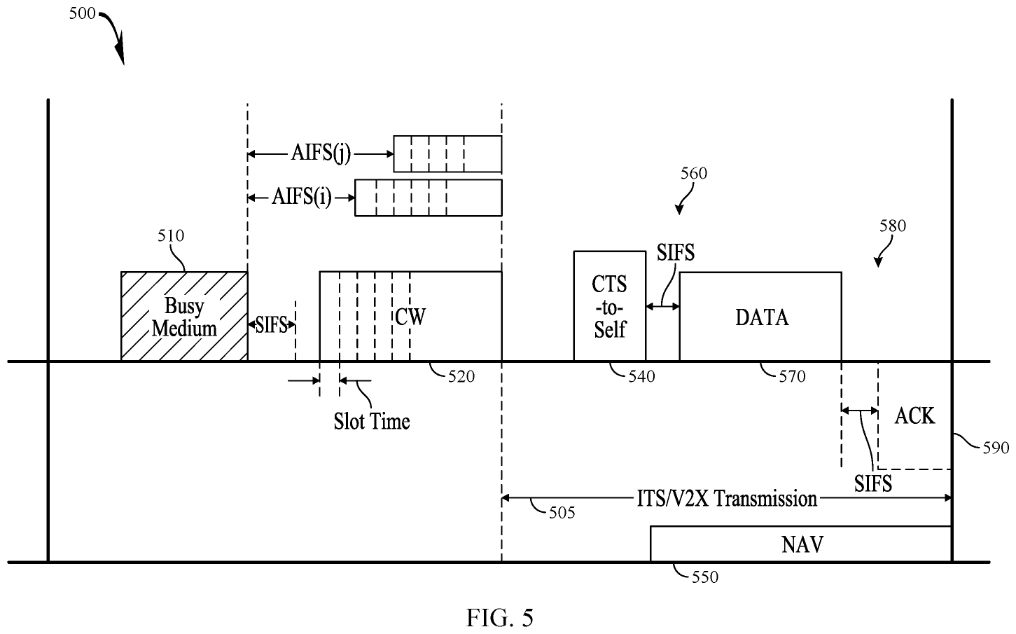

FIG. 5 shows an exemplary transmission timeline 500, of a device operating according to aspects of the present disclosure. In the exemplary transmission timeline, a device (e.g., BS 110a, UE 120a, or UE 120d) intends to transmit an ITS or V2X transmission 505. The device detects another transmission 510 (e.g., by a Wi-Fi device) on the frequencies on which the device intends to transmit. After a contention window (CW) 520, the device senses that the medium and then transmits a CTS-to-self 540. After completing transmission of the CTS-to-self, any Wi-Fi device receiving the CTS-to-self sets a network allocation vector (NAV) and defers from transmitting in the bandwidth, as symbolized at 550. The length of the NAV and the size of the bandwidth are indicated in the CTS-to-self. The device waits a short interframe space (SIFS) 560 and then transmits data 570 on the bandwidth. The length of time that devices defer from transmitting includes both time for the device to transmit data and a SIFS 580, and/or a length of time for another device to transmit an acknowledgment (ACK) 590 of the data. More specifically, the transmission of the ACK by the other device or the reception of the ACK by the device is optional.

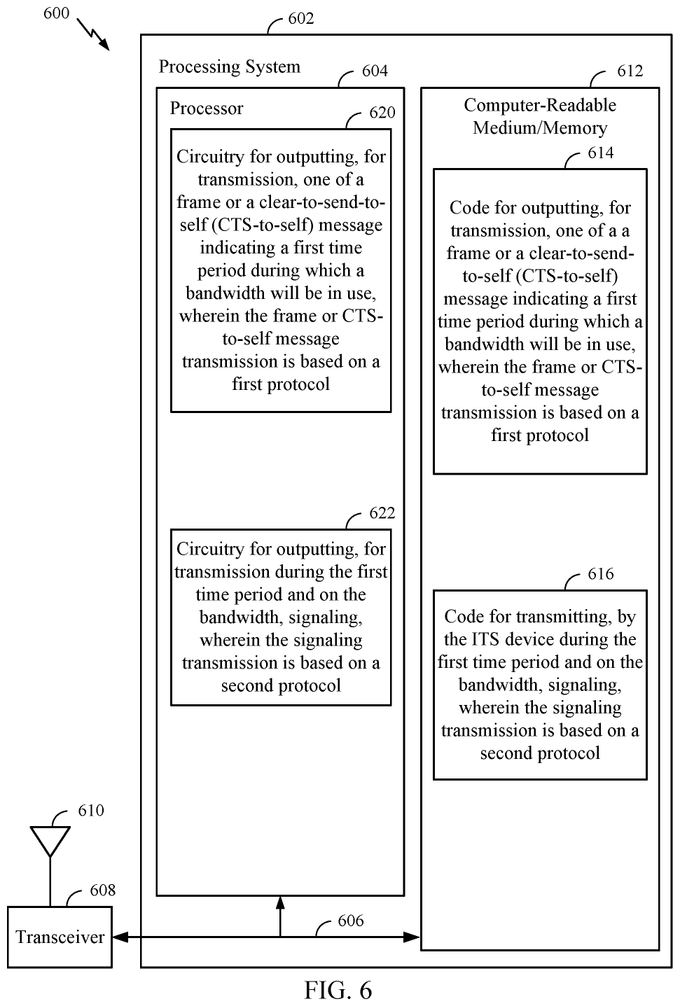

FIG. 6 illustrates a communications device 600 that may include various components (e.g., corresponding to means-plus-function components) configured to perform operations for the techniques disclosed herein, such as the operations illustrated in FIG. 4. The communications device 600 includes a processing system 602 coupled to a transceiver 608. The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes a processor 604 coupled to a computer-readable medium/memory 612 via a bus 606. In certain aspects, the computer-readable medium/memory 612 is configured to store instructions (e.g., computer-executable code) that when executed by the processor 604, cause the processor 604 to perform the operations illustrated in FIG. 4, or other operations for performing the various techniques discussed herein for enabling coexistence between intelligent transportation system (ITS) networks and unlicensed wireless local area networks (WLANs). In certain aspects, computer-readable medium/memory 612 stores code 614 for transmitting, by an intelligent transportation system (ITS) device, one of a frame or a clear-to-send-to-self (CTS-to-self) message indicating a first time period during which a bandwidth will be in use, wherein the frame or CTS-to-self transmission is based on a first protocol; and code 616 for transmitting, by the ITS device during the first time period and on the bandwidth, signaling, wherein the signaling is based on a second protocol. In certain aspects, the processor 604 has circuitry configured to implement the code stored in the computer-readable medium/memory 612. The processor 604 includes circuitry 620 for transmitting, by an intelligent transportation system (ITS) device, one of a frame or a clear-to-send-to-self (CTS-to-self) message indicating a first time period during which a bandwidth will be in use, wherein the frame or CTS-to-self transmission is based on a first protocol; and circuitry 622 for transmitting, by the ITS device during the first time period and on the bandwidth, signaling, wherein the signaling is based on a second protocol.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, processors 266, 258, 264, and/or controller/processor 280 of the UE 120a and/or processors 220, 230, 238, and/or controller/processor 240 of the UE 120d shown in FIG. 2 may be configured to perform operations 400 of FIG. 4.

Means for transmitting may include a transmitter (such as one or more antennas or transmit processors) illustrated in FIG. 2 and means for receiving may include a receiver (such as one or more antennas or receive processors) illustrated in FIG. 2. Means for determining and means for detecting may include a processing system, which may include one or more processors, such as processors 266, 258, 264, and/or controller/processor 280 of the UE 120a and/or processors 220, 230, 238, and/or controller/processor 240 of the UE 120d shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 4.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by an intelligent transportation (ITS) device, comprising:
transmitting one of a frame or a clear-to-send-to-self (CTS-to-self) message indicating a first time period during which a bandwidth will be in use, wherein the transmission of the frame or CTS-to-self message is based on a first protocol; and
transmitting signaling during the first time period and on the bandwidth, wherein the transmission of the signaling is based on a second protocol.

2. The method of claim 1, wherein the first protocol comprises a Wi-Fi protocol and the second protocol is associated with an ITS standard.

3. The method of claim 1, wherein the first time period is a transmission opportunity (TXOP).

4. The method of claim 1, wherein the signaling comprises vehicle mobility data.

5. The method of claim 2, wherein the ITS standard comprises at least one of a dedicated short-range communications (DSRC) standard, a cellular vehicle-to-everything (C-V2X) standard, or an advanced C-V2X standard.

6. The method of claim 1, further comprising determining a length of the first time period based on a quantity of data to be transmitted in the signaling.

7. The method of claim 1, further comprising:
receiving an acknowledgment (ACK) of the signaling during the first time period.

8. The method of claim 7, further comprising determining a length of the first time period based on:
a quantity of data to be transmitted in the signaling; and
a length of time for reception of the ACK.

9. The method of claim 1, further comprising:
detecting a communication in the bandwidth prior to the transmission of the frame or CTS-to-self message, wherein the one of the frame or the CTS-to-self message is transmitted after an expiration of a second time period following the end of the communication.

10. The method of claim 9, wherein the second time period is a distributed coordination function (DCF) interframe space (DIFS) associated with the first protocol.

11. An intelligent transportation (ITS) device, comprising:
a transmitter configured to:
transmit one of a frame or a clear-to-send-to-self (CTS-to-self) message indicating a first time period during which a bandwidth will be in use, wherein the transmission of the frame or CTS-to-self message is based on a first protocol; and
transmit signaling during the first time period and on the bandwidth, wherein the transmission of the signaling is based on a second protocol.

12. The ITS device of claim 11, wherein the first protocol comprises a Wi-Fi protocol and the second protocol is associated with an ITS standard.

13. The ITS device of claim 21, wherein, at least one of:
the first time period is a transmission opportunity (TXOP); or the signaling comprises vehicle mobility data.

14. The ITS device of claim 12, wherein the ITS standard comprises at least one of a dedicated short-range communications (DSRC) standard, a cellular vehicle-to-everything (C-V2X) standard, or an advanced C-V2X standard.

15. The ITS device of claim 11, further comprising a processing system configured to determine a length of the first time period based on a quantity of data to be transmitted in the signaling.

16. The ITS device of claim 11, further comprising:
a receiver configured to receive an acknowledgment (ACK) of the signaling during the first time period.

17. The ITS device of claim 16, further comprising a processing system configured to determine a length of the first time period based on:
a quantity of data to be transmitted in the signaling; and
a length of time for reception of the ACK.

18. The ITS device of claim 11, wherein the processing system is further configured to:
detect a communication in the bandwidth prior to the transmission of the frame or CTS-to-self message, wherein the one of the frame or the CTS-to-self message is transmitted after an expiration of a second time period following the end of the communication.

19. The ITS device of claim 18, wherein the second time period is a distributed coordination function (DCF) interframe space (DIFS) associated with the first protocol.

20. An apparatus for wireless communications, comprising:
a processing system configured to generate:
one of a frame or a clear-to-send-to-self (CTS-to-self) message indicating a first time period during which a bandwidth will be in use; and
signaling; and
an interface configured to output:
one of the frame or the clear-to-send-to-self (CTS-to-self) message for transmission, via a first protocol, during the first time period and on the bandwidth; and
the signaling for transmission, via a second protocol, during the first time period and on the bandwidth.
